(19) United States
(12) Patent Application Publication
(10) Pub. No.: US 2015/0177051 A1
(43) Pub. Date: Jun. 25, 2015

(54) Liquid Management System

(71) Applicant: Liquip International Pty Ltd, Smithfield NSW (AU)

(72) Inventors: Stephen James Hudson, Miranda NSW (AU); Miroslaw Lipinski, Coogee NSW (AU); Shiang Taing, Chester Hill (AU)

(73) Assignee: Liquip International Pty Ltd, Smithfield NSW (AU)

(21) Appl. No.: 14/500,224

(22) Filed: Sep. 29, 2014

(30) Foreign Application Priority Data
Dec. 23, 2013 (AU) 2013905051
Mar. 6, 2014 (AU) 2014201257

(51) Int. Cl. G01F 25/00

(52) U.S. Cl. CPC G01F 25/0007

(57) ABSTRACT

A tanker management system includes an integrated measurement unit that monitors liquid volumes managed by a tanker and records transfer volumes. The measurement unit has a tank interface that receives liquid level measurements for a tanker reservoir and a transfer interface that receives measurements for liquid transfers between the tanker reservoir and external liquid stores. The tanker management system has a control system that calculates the volume of liquid retained in the tanker reservoir, based on the received level measurements, and the volume of liquid exchanged with an external liquid store, based on the received measurements. The control system and measurement unit are an integrated unit within a unitary housing that includes an operator interface.

This application claims priority to Australian patent application No. 2013905051 filed Dec. 23, 2013; and Australia patent application No. 2014201257 filed on Mar. 6, 2014, the entire contents of which are incorporated herein by reference.

### BACKGROUND

The disclosure of this specification relates to management systems for tankers, including volumetric measurement units capable of monitoring reservoir level and transfer flow rate.

Road tankers are widely used to distribute bulk liquids. Common liquids transported by road tankers include fuels (such as gasoline and diesel), consumables (such as milk) and chemicals (such as acids and caustic).

Tankers are often used to distribute liquids from a single source (such as a processing or storage facility) to several spatially separated recipients. Each recipient is usually charged in proportion to the quantity of liquid they receive. The tanker operator is usually responsible for recording transfer volumes and accounting for each delivery made by tankers in their fleet.

### SUMMARY

In a first aspect, the present invention provides a tanker management system comprising an integrated measurement unit that monitors liquid volumes managed by a tanker and records transfer volumes, the measurement unit having a tank interface that receives liquid level measurements for a tanker reservoir and a transfer interface that receives flow rate measurements for liquid transfers between the tanker reservoir and external liquid stores, the tanker management system having a control system that calculates the volume of liquid retained in the tanker reservoir, based on the received level measurements, and the volume of liquid exchanged with an external liquid store, based on the received flow rate measurements, the control system being integrated with the measurement unit within a unitary housing.

In an embodiment, the system comprises an operator interface integrated with the measurement unit that facilitates interaction with a tanker operator, the operator interface including a screen that displays the reservoir and transfer volumes calculated for the tanker during a liquid exchange.

In an embodiment, the system comprises a calibration module that reconciles changes in the tanker reservoir volume derived from the level measurement with the transfer volumes calculated from flow rate measurements to calibrate the level measurements.

In an embodiment, the system comprises an actuation module that facilitates transfer volume control via the operator interface, the actuation module receiving volumetric settings that define the quantity of liquid to be transferred between the tanker reservoir and an external liquid store during a liquid exchange and controlling the transfer volume responsive to the received volumetric settings.

In an embodiment, the system comprises a recording module that records the volume of liquid retained in the tanker reservoir following each liquid exchange and the volume of liquid transferred between the tanker reservoir and an external liquid store during each liquid exchange in memory.

In an embodiment, the system comprises a reporting module that reconciles changes in the tanker reservoir volume with the volume of liquid transferred during each liquid exchange and identifies discrepancies between the tanker volume and transfer volume.

In a second aspect, the present invention provides a tanker management process comprising:
a dedicated tanker measurement unit recursively calculating reservoir volume from liquid level measurements received during liquid exchanges,
the dedicated tanker measurement unit totalising the volume of liquid transferred between the reservoir and external liquid stores during each of the liquid transfers based on received flow rate measurements,
the dedicated tanker measurement unit reconciling the totalised volumetric transfer between the tanker and external liquid stores with calculated reservoir volume changes to determine volumetric compliance, and
the dedicated tanker measurement unit generating an alarm when discrepancies between the totalised transfer volume and the calculated reservoir volume changes exceed a defined reporting threshold.

### BRIEF DESCRIPTION OF THE DRAWINGS

Features and advantages of the present invention will become apparent from the following description of embodiments thereof, by way of example only, with reference to the accompanying drawings in which:

FIG. 1a is a top view of a tanker depicting the position of a level sensor within a liquid reservoir.

FIG. 1b is a front cross-section of the tanker illustrated in FIG. 1a depicting the position of the level sensor relative to a mechanical measurement gauge.

FIG. 2 is a block representation of the functional components of a tanker management system depicting the relationship between functional system components.

FIG. 3 is a circuit diagram depicting various I/O interfaces for a tanker management system.

FIG. 4 is a perspective view of an embodiment of tanker management system.

FIG. 5 is a perspective view of an embodiment of an operator interface keypad.

FIG. 6 is a schematic representation of the electrical components housed within the tanker management system illustrated in FIG. 4.

FIG. 7 is a tanker management process diagram depicting independent level and flow rate monitoring and calculation function.

### DETAILED DESCRIPTION

An embodiment of a tanker management system is disclosed in this specification. The system facilitates volumetric monitoring of liquid volumes delivered to recipients within a distribution network. This allows tanker operators to accurately account for the liquid transported by individual tankers within a fleet and identify volumetric discrepancies. The system also records the liquid volumes transferred to external liquid stores during distribution.

The disclosed tanker management system incorporates a measurement unit that monitors the level of liquid within the tanker reservoir and the volume of liquid transferred between the tanker and external reservoirs. The tanker may discharge liquid from the tanker reservoir to an external liquid store (such as a refueling another vehicle) or receive liquid from an external liquid store. An integrated control system calculates the volume of liquid within the tanker reservoir and the transfer volume from the respective measurements.

The tanker management system may also be capable of reconciling volumetric changes within the liquid reservoir with the transfer volume attributed to each external liquid store. Discrepancies between the transfer volumes derived from the respective measurements are usually recorded in a transfer report for the corresponding tanker. The tanker management system can automatically generate customised transfer reports that document tanker operations and facilitate statistical profiling. The disclosed system is capable of identifying volumetric discrepancies that exceed a defined calibration threshold.

The tanker management system stores the volumetric records for a tanker within non-volatile system memory. The measurement unit ideally stores the transfer volumes derived from the liquid level and flow rate measurements independently.

An individual tanker may have several isolated liquid reservoirs (typically formed by partitions within a shared outer structure). The disclosed tanker management system is capable of monitoring the level of liquid within a plurality of independent tanker reservoirs.

The volumetric records stored for a tanker are accessible via a communications interface. The communications interface allows tanker operators to extract data (typically measurements and volumetric records) from the tanker management system.

The measurement unit has an integrated control system that interfaces with the tankers on-board sensor network. The control system has dedicated I/O interfaces (input/output interfaces) that receive measurement signals from various sensors. Typical sensors include level sensors installed in the tanker reservoirs, a flow rate sensor installed in the transfer pipework and a temperature sensor disposed adjacent the liquid reservoir. The tanker management system uses the measurements derived from the sensors to calculate the liquid volume maintained in the tanker reservoir(s) and transfer volumes between the tanker and external liquid stores. Flow rate measurements are typically transmitted to the measurement unit via a series of pulses (where each pulse represents a set liquid volume).

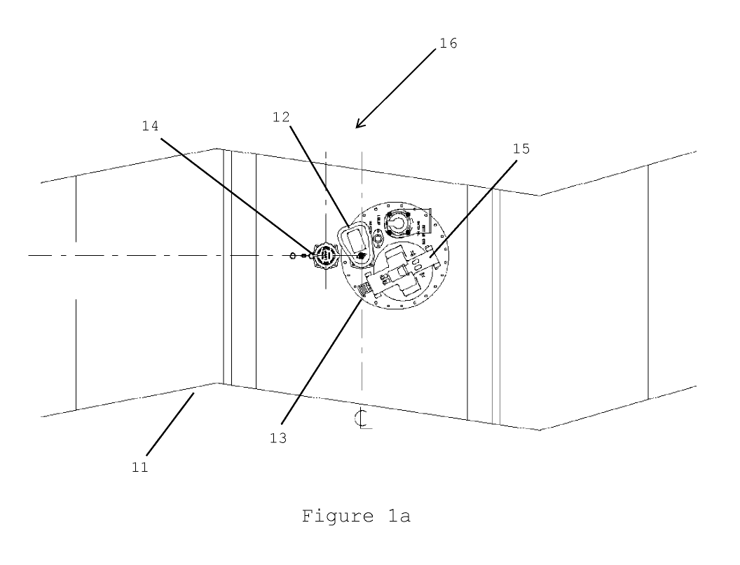

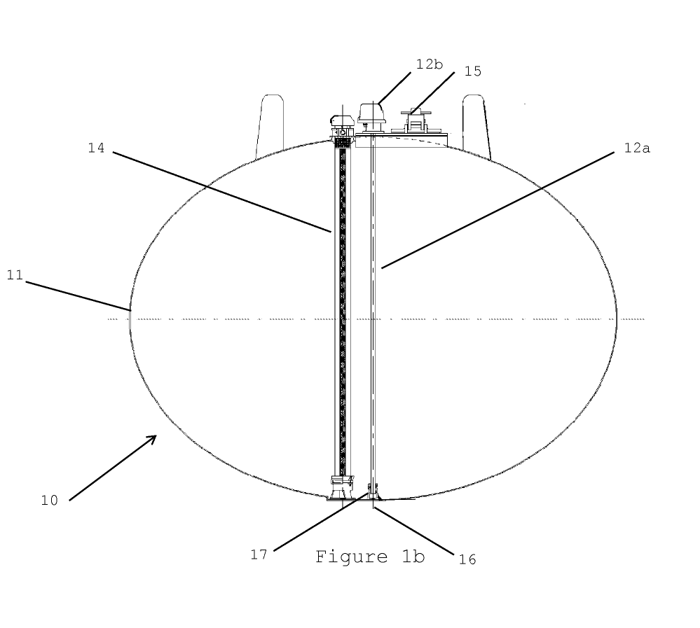

A road tanker 10 is depicted in FIGS. 1a and 1b. FIG. 1a depicts a top elevation of a tanker reservoir 11 showing an instrument group. The depicted instrument groups include a level sensor 12. The level sensor 12 is mounted to a cover plate 13 (disposed on the tanker ‘walkway’) that provides access to the reservoir. The cover plate 13 includes an access hatch 15 (such as a ‘manhole’ cover) that seals the tanker reservoir 11 when closed. Other instruments (such as a temperature sensor) and/or regulatory components (such as pressure relief vents) may be mounted to the cover plate 13.

A mechanical level measurement gauge 14 is disposed adjacent the cover plate 13. The level gauge 14 facilitates provides a failsafe level measurement alternative.

A cross-section through the tanker reservoir 11 is depicted in FIG. 1 b. The illustrated level sensor probe 11a extends generally parallel with the level gauge 14 from the cover plate 13 (disposed in the top of the tanker reservoir 11) to the base of the reservoir 11. Both the level sensor probe 12a and level gauge 14 are disposed in an upright position so that they are generally vertical when the tanker is positioned on level ground. The illustrated level sensor probe 12a is disposed coincident with the volumetric centre line 16 of the reservoir 11. This position improves the accuracy of level measurements by eliminating lateral bias (created when the tanker is positioned on uneven ground).

A level sensor transmitter 12b transmits measurements from the level sensor probe 12a to a centralised tanker management system. The illustrated level sensor transmitter 12b is mounted to the access cover 13. The level sensor probe 12a is supported adjacent the base of the reservoir 11 by an auxiliary mounting bracket 17. The illustrated mounting bracket 17 is a guide for the level sensor probe 12a (the probe 12a is not fastened to the mounting bracket 17 in the illustrated embodiment). The probe 12a mounting sites (the access cover 13 and mounting bracket 17) ensure that the level sensor probe 12a remains upright within the tanker reservoir 11. A similar mounting configuration may be used for the level gauge 14. The level gauge 14 is an optional failsafe component.

Road tankers often have several distinct liquid reservoirs 11 that are hermetically separated. This allows an individual tanker to transport several different liquids (such as different fuel grades and types) without cross-contamination. The individual liquid reservoirs may be isolated by partition walls dispersed within a common reservoir structure 11. Each liquid reservoir typically has a dedicated level sensor 12. They may also have dedicated measurement gauges 14 and access hatches 15.

Multi-reservoir tankers typically employ a centralised liquid transfer system that links each reservoir to shared pipework. Shared transfer systems typically employ a manifold and valve network to link individual reservoirs with the shared pipework. A flow rate sensor is typically integrated with a branch of the shared pipework. Conventional flow rate sensors monitor the volume of liquid channeled through a calibrated orifice. The sensor unit totalises the volume of liquid passing via the orifice and generates a pulse signal the accumulated volume exceeds a set threshold (each pulse corresponding to a preconfigured volume of liquid).

The flow rate sensor monitors the quantity of liquid transferred between the tanker and external liquid stores (such as a liquid depot or the fuel tank of another vehicle). Measurements from the flow rate sensor are typically transmitted to the measurement unit via a series of pulses (where each pulse represents a set liquid volume). The tanker management system calculates transfer volumes from the pulses produced by the flow rate sensor.

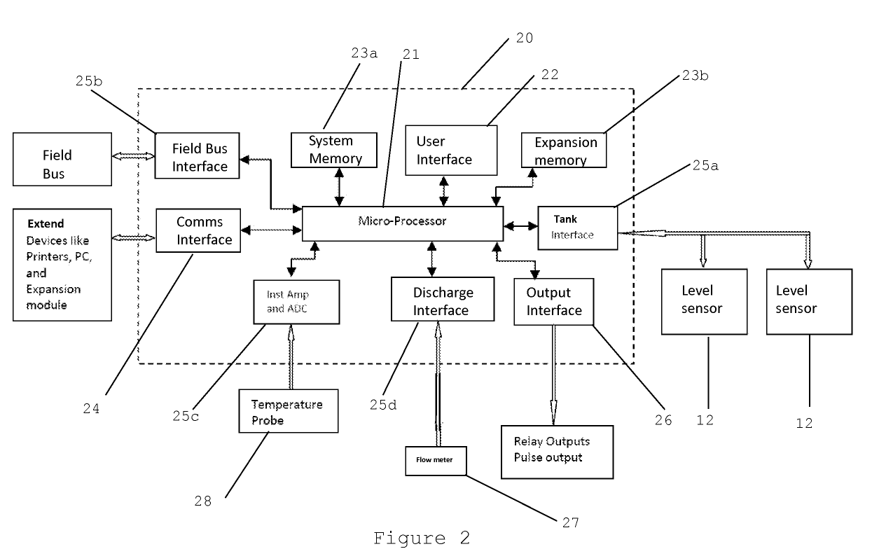

A functional representation of a tanker management system 20 is depicted in FIG. 2. The illustrated system 20 comprises discrete component blocks that represent the function and interaction of various system components. The depicted system components are integrated within a unitary housing (delineated by the dashed line). The tanker level sensor 12 and flow meter 27 typically communicate with the tanker management system 20 via a field bus (such as a HART or CAN bus). The flow meter 27 may alternatively use digital pulse signals derived from a pulse conversion device interfaced with flow meter. The field bus may transfer data between the tanker management system 20 and external devices.

The tanker management system 20 control system 21 coordinates operation of the various system components. The illustrated control system 21 is implemented in a dedicated microprocessor or microcontroller.

The control system 21 has several I/O interfaces. The I/O interfaces facilitate communication with peripheral components (such as the flow meter 27 and level sensor(s) 12) by converting received signals into a format that is compatible with the control system processing unit.

The illustrated tanker management system 20 has a dedicated tank interface 25a that receives liquid level measurements for the tanker reservoir 11 from the level sensor 12. The tank interface 25a is capable of supporting a plurality of level sensors 12. The illustrated tanker management system 20 also incorporates an independent transfer interface 25d for the flow meter 27. The transfer interface 25d receives flow rate measurements for liquid exchanges between the tanker reservoir 11 and an external liquid store. The respective interfaces (tank interface 25a and transfer interface 25d) may be implemented in a consolidated field bus network or independent I/O channels.

The control system 21 executes separate measurement and actuation functions. These functions may be implemented in different processing units (such as independent microcontrollers) or integrated in a single chip.

The control system measurement unit uses the signals received from the level sensor 12 and flow rate sensor to calculate the tanker reservoir volume and transfer volume. The reservoir and transfer volumes are typically stored in non-volatile memory (either a system memory module 23a or expansion memory 23b) by a recording module (integrated with the control system 21).

A reporting module (integrated with the control system 21 in some embodiments) reconciles changes in the reservoir volume with the transfer volumes derived from the flow rate meter for each liquid transfer. The reporting module can be configured to identify discrepancies that exceed a defined threshold (the ‘calibration threshold’). These discrepancies are recorded in non-volatile memory by the recording module. The tanker management system 20 facilitates access to the volumetric data stored by the recording module through an integrated communications interface 24. The user interface 22 enables the tanker operator to access the contents of system memory 23a and retrieve recorded data (such as the latest transfer volume recorded by the system 20). Data stored in expansion memory 23b may also be accessed via the communications interface 24. The communications interface 24 typically operates a standardised communications protocol (such as RS232, USB, Bluetooth or WiFi).

The tanker management system 20 includes an operator interface 22 that facilitates interaction with a tanker operator during liquid deliveries. The operator interface 22 includes a display screen that facilitates ‘real-time’ volumetric reporting. The control system 21 operates the operator interface display screen during liquid exchange operations to display the reservoir and transfer volumes calculated by the measurement unit. The operator interface 22 may also receive input from the tanker operator (typically through a touchscreen display or dedicated keypad).

An actuation module controls the tanker management system outputs. The actuation module is implemented by the control system 21 in the functional system diagram presented in FIG. 2. An output interface 26 connects the control system 21 to the system outputs. Typical outputs include manifold valves (usually relay operated solenoids), a transfer pump (such as a pulse operated diaphragm pump) and remote devices (such as external display units). The actuation module may implement an automated transfer sequence or receive manual instructions from a tanker operator via the operator interface 22.

The actuation module is interfaced with the measurement unit to coordinate automation of the liquid transfer process. The actuation module regulates the activation and deactivation of the transfer system (typically the manifold valves) responsive to the transfer volume derived by the measurement unit.

The transfer volume for a liquid transfer is typically specified by the tanker operator. The control system 21 receives the operator specified transfer volume (the ‘transfer set-point’) via the operator interface 22. This set-point is stored in a dedicated register in system memory 23a. It may also be recorded in a transfer log.

The control system 21 initiates an automated transfer by initialising a transfer totalizer (typically a dedicated register allocated within system memory 23a). The measurement unit maintains a transfer volume total in the totalizing register during each transfer cycle. The transfer totalizer represents the volume of liquid transferred from the tanker during a defined transfer cycle.

The actuation module uses the transfer volume totalizer and the operator set-point to control the state of the transfer system. This includes energising/de-energising manifold valves and transfer pump(s). The actuation module creates a transfer passage between a selected reservoir and shared pipework by opening the applicable manifold valves. This facilitates the exchange of liquid with an external liquid store, such as discharging liquid from the reservoir to an external destination via the pipework via a gravity fed system or with the aid of a transfer pump.

The flow of liquid through the share pipework is monitored by the measurement unit (usually via pulse signals indicative of the flow rate through the shared pipework). The measurement unit calculates an instantaneous transfer volume from the flow rate measurements and maintains a cumulative total in the transfer totalizing register. The actuation module breaks the transfer passage when the accumulated volume reaches the defined operator set-point by closing the applicable manifold valves. This stops the liquid transfer process.

The control system 21 may also incorporate a calibration module that reconciles changes in the tanker reservoir volume (derived from level measurements) with the transfer volumes (calculated from flow rate measurements) to calibrate the measurement unit. Calibration changes are typically applied to the level sensor 12 if there are inconsistencies between the respective measurements (flow meter 27 calibration is typically regulated by an independent authority).

The calibration module may use the temperature of liquid within a reservoir to compensate for thermal expansion during calibration. Temperature changes typically have a greater effect on the flow rate measurements and can lead to volumetric discrepancies when there is no temperature compensation. The temperature sensor 28 illustrated in FIG. 2 connects to the control system 21 via a dedicated temperature interface 25c.

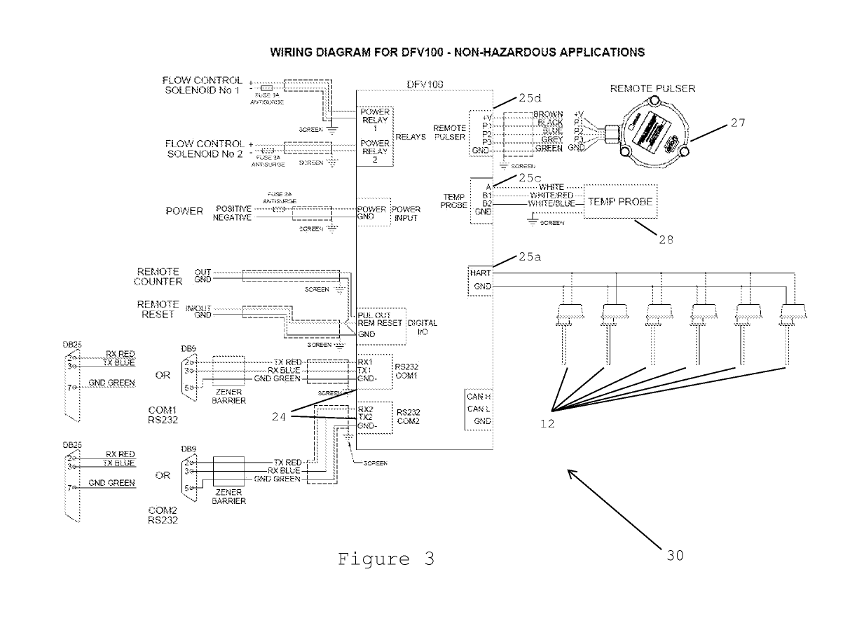

A wiring diagram for an on-board tanker management system 30 is depicted in FIG. 3. The diagram depicts the I/O interface layout for a tanker management system 30 with integrated measurement unit and control system. The illustrated system layout allows the tanker management components (including a tank interface and transfer interface) to be integrated in a unitary housing that is mounted to a tanker (such as an on-road fuel or milk tanker).

Combining the measurement components of the tanker management system 20 in an integrated unit produces a centralised interface for monitoring and regulation of the tanker transfer system. It also enables the installation costs to be reduced (as the system components can be housed in a unitary shell) and can reduce the overall complexity of the system (as each measurement can be displayed on a shared operator interface). Volume and flow rate/transfer volume measurements are typically managed by separate units in conventional on-board tanker systems.

The illustrated tanker management system 30 is capable of interfacing with a plurality of level sensors 12 via a Highway Addressable Remote Transducer Protocol (HART) interface. Dedicated temperature 25c and transfer 25d interfaces connect the tanker management system 30 with individual temperature 28 and flow 27 sensors respectively. The illustrated communications interface 24 comprises two independent RS232 ports.

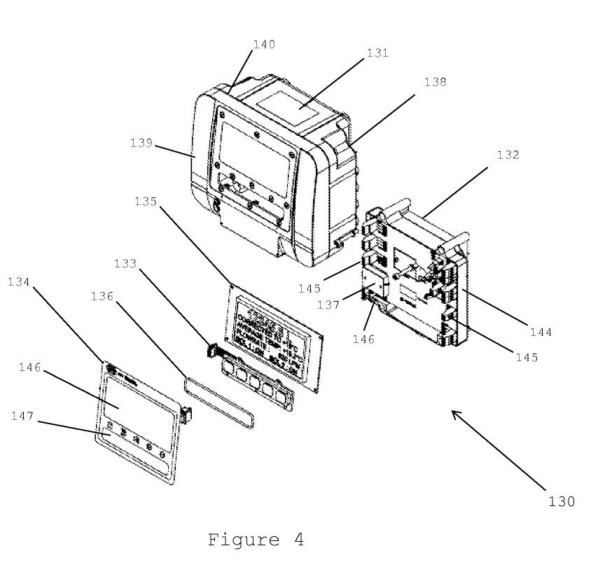

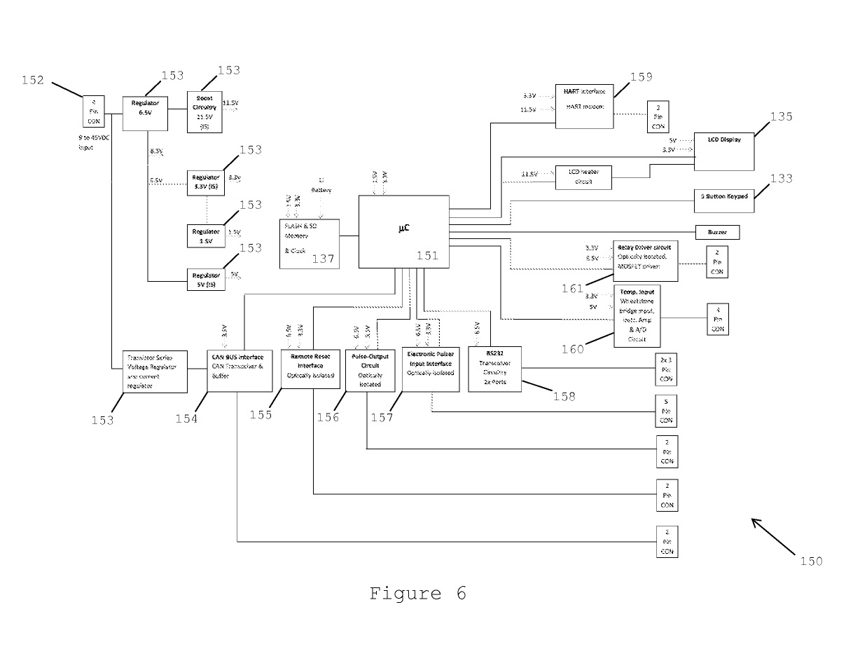

A modular tanker management assembly 130 is depicted in FIG. 4. The illustrated tanker management system 130 comprises a replaceable electronics module 132 that houses the systems electronics (including the main PCB, control system and power supply). A schematic representation of the electronics components 150 housed in the illustrated electronics module 132 is depicted in FIG. 6.

The electronics module 132 illustrated in FIG. 6 uses a centralised control system 151 to regulate operation of the tanker management system. The control system 151 includes dedicated operational memory (such as non-volatile memory for firmware and temporary read-write memory). The illustrated electronics module 132 also incorporates system memory (including expansion slot 137) that the control system can access (typically for tanker records and fault logging). The expansion slot 137 can facilitate firmware updates using external media (such as an SD card).

The depicted control system 151 communicates with external components via a series of I/O (input/output) interfaces. The depicted interfaces include:

HART field bus 159

CAN field bus 154

temperature input 160

RS232 interface 158

relay drive circuit 161

pulse output interface 156

pulse input interface 157

remote reset interface 155

The system electronics 150 are connected to the tanker electrical system via a single power interface 152. Power electronics 153 are connected between the power interface 152 and remaining system electronics 150. The power electronics 152 regulate power supplied by the tanker electrical system for use by the control system, I/O interface components (including dedicated I/O controllers) and other system components.

The electronics module 132 encapsulates the system electronics in a casing 144 (usually fabricated from a suitable polymer, such as nylon). The casing 144 has a plurality of releasable mechanical connectors that mount the electronics module 132 within the assembly housing 131. The connectors 144 engage with complimentary interfaces (not shown) that are disposed within the assembly housing 131. The illustrated connectors 144 are male snap lock fastener plugs.

The electronics casing 144 is typically filled with a potting compound (such as polyurethane or silicone) that encases the system electronics to improve vibration resilience and corrosion resistance. The potting compound may also electrically seal the electronics module 132 to ensure safe operation in hazardous environments. An electronics interface 145 facilitates connections between the system electronics and external components (such an operator interface). The illustrated electronics module 132 incorporates a memory expansion slot 137 that receives auxiliary memory modules (such as SD cards, USB sticks or similar memory devices).

The modular tanker management assembly 130 includes a housing 131 that the electronics module 132 mounts within. The illustrated housing 131 is metallic. Common materials for the housing include aluminium (including powder coated and anodised aluminium), steel (including stainless and chromoly steel), titanium, brass (including plated brass) and other metals with suitable corrosion resistance (including painted, plated and galvanised metals). The housing 131 is typically fabricated from a metal that is suitable for use in hazardous environments and is generally more durable than polymer alternatives (metals generally has greater impact resistance, improved thermal characteristics and better resilience to UV radiation).

The illustrated housing 131 comprises two shells (front shell 139 and rear shell 138). The shells 138, 139 mate at junction 140 that is roughly parallel with the front face of the housing 131. A perimeter seal is disposed between the respective shells 138, 139 at the junction 140. The seal is typically formed from a resilient material (such as rubber or silicon) that resists liquid ingress. The mating surfaces of the respective shells 138, 139 define a recessed channel that extends about the perimeter of the junction 140. The seal seats within the recessed channel and is compressed by the shells 138, 139 when the housing is assembled.

The base 138 of the housing mounts the assembly 130 to a tanker. The outer shell 139 engages with the base 138 to enclose the electronics module 132. The housing shells 138, 139 may be secured with fasteners, releasable snap lock connectors, a hinge joint or another releasable closure mechanism. The outer shell 139 of the illustrated assembly 130 can be removed without disturbing the base/tanker mount to facilitate access to the electronics module 131. The modular configuration of the illustrated tanker management assembly 130 allows the electronics module 132 to be upgraded or replaced without dismounting the housing 131.

The operator interface for the illustrated assembly 130 comprises an industrial LCD display 135 and physical keypad 133. The depicted LCD has a five line display. This interface may be supplemented or superseded by a touchscreen display for less demanding applications (the illustrated keypad 133 and display 135 are more durable that widely available touchscreen displays). The illustrated display 135 and keypad 133 are electrically sealed for use in hazardous environments.

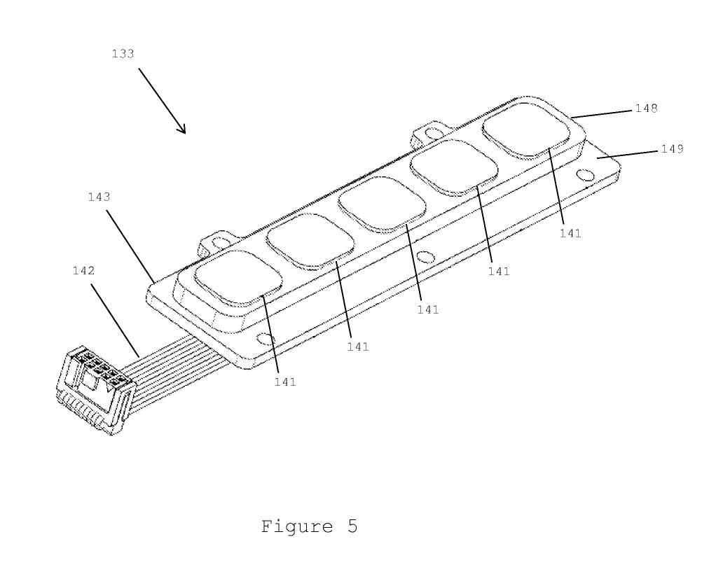

An enlarged representation of the keypad 133 is presented in FIG. 5. The illustrated keypad 133 has a split level housing 143 with a base section 149 that mounts adjacent the electronics module 132. Five buttons 141 are mounted within the housing 143. The buttons are housed within a raised section 148 of the housing 143. The base 149 and raised 148 sections of the housing 143 are separated by a step junction.

The housing 143 is typically metallic and may be fabricated from similar material as the assembly housing 131. The illustrated housing is fabricated from anodised aluminium.

The keypad 133 may have an indicator (such as a piezo transducer for audio confirmation) that the operator interface 22 activates when user input (via one of the buttons 141) is received. The illustrated keypad 133 is interfaced with the electronics module 132 by a ribbon cable 142. A keypad seal 136 resists water ingress between the housing 131 and keypad 133.

The operator interface depicted in FIG. 4 implements a nested menu structure that is navigated via the keypad 133. The tanker management system 20 uses the menu structures to dynamically allocate functions to the keypad buttons 141. The electronics module 132 links individual buttons within the keypad 133 to predefined menu options presented on the display 135. The allocated function of each button 141 is displayed along the lower edge of the display 135 adjacent the respective button. Some buttons may have static or recurring functions that facilitate recurrent options (such as calibration) or menu navigation (such as ‘back’ or ‘home’ buttons). The menu structure and keypad function may be upgradable via firmware revision.

The electronics module 132 has an electrical interface that connects the display 135 and keypad 133 to the electrical components encased in the potting compound. The display 135 and keypad 133 mount to the front surface of the assembly housing 131 adjacent the electrical interface. The front of the housing 131 is sealed by a cover panel 134 that mounts adjacent the keypad 133 and display 135. The cover panel 134 has a transparent screen 146 that protects the display from impact damage and chemical spills. The screen 134 is usually fabricated from a suitable polymer (such as polycarbonate), although shatter resistant glass and other alternatives may be used. The illustrated cover panel 134 has an opening that is generally commensurate with the raised section 148 of the keypad 133.

The keypad 133 mounts to an inner surface of the front shell 139. A polymer seal 136 (typically made from a silicone compound) seats between the front shell 139 and the keypad 133 when the tanker management assembly 130 is assembled. The seal is compressed when the keypad 133 is secured to the front shell 138, creating a barrier to liquid and dust ingress. Similar seals (not shown in the drawings) are seated between the shells 138, 139 of the assembly housing 131.

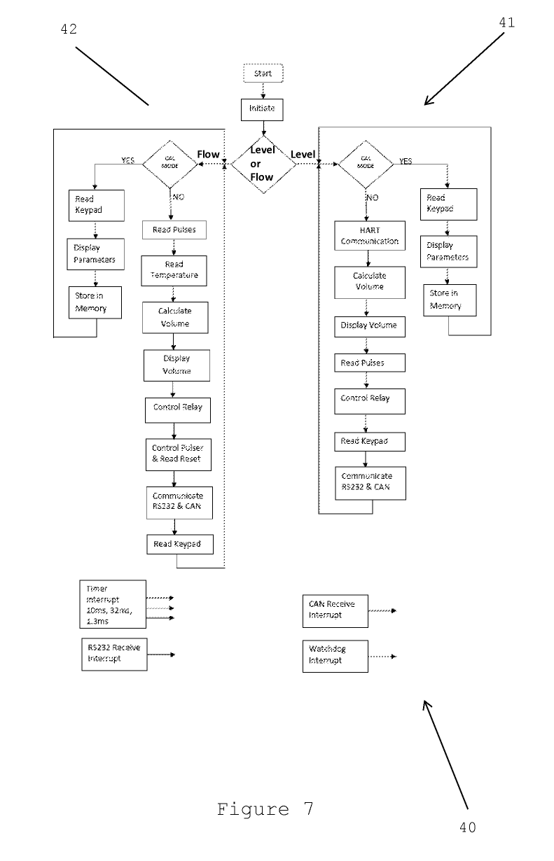

A process flow diagram 40 for the measurement unit is depicted in FIG. 7. The illustrated process flow diagram 40 depicts the typical operation of the management system 20 firmware. The flow diagram illustrates independent flow 42 and level 41 transfer control sequences. The illustrated flow control sequence includes thermal compensation for volume calculations. Both transfer processes incorporate an independent calibration cycle (typically initiated via a calibration selection in the menu structure for each sequence). The respective control processes can be initiated via a selector switch accessible through the operator interface 22 via an initial menu. The keypad 133 illustrated in FIGS. 4 and 5 is used to select measurement functionality (flow or volume control) and initiate sub-routine functions.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

1. A modular tanker management unit comprising:
a tank interface that receives liquid level measurements for a tanker reservoir,
a transfer interface that receives flow rate measurements for liquid transfers between the tanker reservoir and external liquid stores,
system electronics that process measurements received via the respective interfaces to calculate the volume of liquid retained in the tanker reservoir and the volume of liquid exchanged with an external liquid store, and
a replaceable electronics module that houses the system electronics, the electronics module being replaceable whereby the system electronics can be upgraded.

2. The unit of claim 1 comprising a metallic casing that houses the electronics module, tank interface and transfer interface.

3. The unit of claim 1 comprising an operator interface comprising a multifunction LCD display that interfaces with the electronics modules.

4. The unit of claim 1 comprising a selector switch that designates one of the tank interface and transfer interface for liquid volume calculations.

5. The unit of claim 1 comprising a selector switch that designates one of the liquid level measurements and flow rate measurements for presentation on the LCD display.

6. The unit of claim 1 comprising a physical keypad with a metallic housing, the keypad having a ribbon cable that connects with the replaceable electronics module via a compatible interface.

7. The unit of claim 1 comprising a control system implemented by the system electronics that calculates liquid volumes in the tanker reservoir based on received level measurements and liquid volumes exchanged with an external liquid store based on received flow rate measurements.

8. The unit of claim 7 comprising a calibration module implemented by the system electronics that reconciles changes in tanker reservoir volume derived from the level measurement with the transfer volumes calculated from flow rate measurements to calibrate the level measurements.

9. The unit of claim 7 comprising an actuation module implemented by the system electronics that facilitates transfer volume control via the operator interface, the actuation module receiving volumetric settings that define the quantity of liquid to be transferred between the tanker reservoir and an external liquid store during a liquid exchange and controlling the transfer volume responsive to the received volumetric settings.

10. The unit of claim 7 comprising a recording module implemented by the system electronics that records the volume of liquid retained in the tanker reservoir following each liquid exchange and the volume of liquid transferred between the tanker reservoir and an external liquid store during each liquid exchange.

11. The unit of claim 10 comprising a reporting module implemented by the system electronics that reconciles changes in the tanker reservoir volume with the volume of liquid transferred during each liquid exchange and identifies discrepancies between the tanker volume and transfer volume.

12. The unit of claim 7 comprising a temperature interface that receives temperature measurements for the liquid retained in the tanker reservoir, the control system being configured to use the received temperature measurements to compensate for thermal expansion and contraction in the calculation of the tanker reservoir volume.

13. The unit of claim 7 comprising a communications interface that transfers stored volumetric data from the tanker management system to an external logging system.

14. A tanker management system comprising an integrated measurement unit that monitors liquid volumes managed by a tanker and records transfer volumes, the measurement unit having a tank interface that receives liquid level measurements for a tanker reservoir and a transfer interface that receives flow rate measurements for liquid transfers between the tanker reservoir and external liquid stores, the tanker management system having a control system that calculates the volume of liquid retained in the tanker reservoir, based on the received level measurements, and the volume of liquid exchanged with an external liquid′ store, based on the received flow rate measurements, the control system being integrated with the measurement unit within a unitary housing.

15. The system of claim 14 comprising an operator interface integrated with the management system that facilitates interaction with a tanker operator, the operator interface including a screen that displays the reservoir and transfer volumes calculated for the tanker during a liquid exchange.

16. The system of claim 15 comprising a calibration module that reconciles changes in the tanker reservoir volume derived from the level measurement with the transfer volumes calculated from flow rate measurements to calibrate the level measurements.

17. The system of claim 15 comprising an actuation module that facilitates transfer volume control via the operator interface, the actuation module receiving volumetric settings that define the quantity of liquid to be transferred between the tanker reservoir and an external liquid store during a liquid exchange and controlling the transfer volume responsive to the received volumetric settings.

18. The system of claim 14 comprising a recording module that records the volume of liquid retained in the tanker reservoir following each liquid exchange and the volume of liquid transferred between the tanker reservoir and an external liquid store during each liquid exchange.

19. The system of claim 18 comprising a reporting module that reconciles changes in the tanker reservoir volume with the volume of liquid transferred during each liquid exchange and identifies discrepancies between the tanker volume and transfer volume.

20. The system of claim 14 comprising a temperature interface that receives temperature measurements for the liquid retained in the tanker reservoir, the measurement unit control system being configured to use the received temperature measurements to compensate for thermal expansion and contraction in the calculation of the tanker reservoir volume.

21. The system of claim 14 comprising a communications interface that transfers stored volumetric data from the tanker management system to an external logging system.

22. A tanker management process comprising:
a dedicated tanker measurement unit recursively calculating reservoir volume from liquid level measurements received during liquid transfers,
the dedicated tanker measurement unit totalising the volume of liquid exchanged between the reservoir and an external liquid stores during each of the liquid transfers based on received flow rate measurements,
the dedicated tanker measurement unit reconciling the totalised volumetric transfer between the tanker and external liquid stores with calculated reservoir volume changes to determine volumetric compliance, and
the dedicated tanker measurement unit generating an alarm when discrepancies between the totalised transfer volume and the calculated reservoir volume changes exceed a defined reporting threshold.
